(19) United States
(12) Patent Application Publication
(10) Pub. No.: US 2019/0087777 A1
(43) Pub. Date: Mar. 21, 2019

(54) TECHNOLOGIES FOR FACILITATING THE SAFE AND ANONYMOUS TRANSPORT OF GOODS BETWEEN A BUYER AND SELLER

(71) Applicant: Shipper Technologies LLC, Indianapolis, IN (US)

(72) Inventors: Nickolas Turner, Indianapolis, IN (US); Blaine Dirker, Bargersville, IN (US)

(21) Appl. No.: 16/133,901

(22) Filed: Sep. 18, 2018

Related U.S. Application Data
(60) Provisional application No. 62/560,831, filed on Sep. 20, 2017.

(51) Int. Cl. G06Q 10/08; G06Q 30/06

(52) U.S. Cl. CPC G06Q 10/0836; G06Q 10/0832; G06Q 30/0609; G06Q 30/0615

(57) ABSTRACT

A method for electronically facilitating the facilitating the safe and anonymous transport of goods between a buyer and seller according to one embodiment includes determining a buyer's location and a seller's location, scheduling transport of the item from the seller's location to the buyer's location, determining a driver for transport of the item based on a description of the item and a pool of active drivers within a threshold proximity of the seller's location, monitoring for fluctuations in an estimated time of arrival of driver at each of the seller's location and the buyer's location based on a real-time geographical location of the driver, and transmitting a notification in response to a determination that the estimated time of arrival has deviated by at least a threshold amount.

### CROSS-REFERENCE TO RELATED APPLICATIONS

This application claims the benefit of U.S. Provisional Application No. 62/560,831 filed on Sep. 20, 2017, the contents of which are incorporated herein by reference in their entirety.

### BACKGROUND

Online marketplaces continue to bring buyers and sellers together for the exchange of goods, both old and new. However, coordinating a time and location for the exchange is burdensome, and the risks involved in actually making the exchange are undeniable. If the exchange occurs at the residence or workplace of the buyer or seller, the residence or workplace may be surveyed for subsequent burglary. Even if the exchange occurs in at a neutral location, each party bears the serious risk of potentially being assaulted, fleeced, robbed, or worse.

### SUMMARY

According to an embodiment, a method for electronically facilitating the facilitating the safe and anonymous transport of goods between a buyer and seller may include determining a buyer's location and a seller's location, scheduling transport of the item from the seller's location to the buyer's location, determining a driver for transport of the item based on a description of the item and a pool of active drivers within a threshold proximity of the seller's location, monitoring for fluctuations in an estimated time of arrival of driver at each of the seller's location and the buyer's location based on a real-time geographical location of the driver, and transmitting a notification in response to a determination that the estimated time of arrival has deviated by at least a threshold amount.

Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of a system for facilitating the safe and anonymous transport of goods between a buyer and seller;

FIG. 2 is a simplified block diagram of at least one embodiment of a buyer device of the system of FIG. 1;

FIGS. 3-5 are a simplified flow diagram of at least one embodiment of a method for facilitating the safe and anonymous transport of goods between a buyer and seller;

FIG. 6 is a simplified flow diagram of at least one embodiment of a method for scheduling the transport of the item; and

FIG. 7 is a simplified flow diagram of at least one embodiment of a method for determining a driver for the transport of the item.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

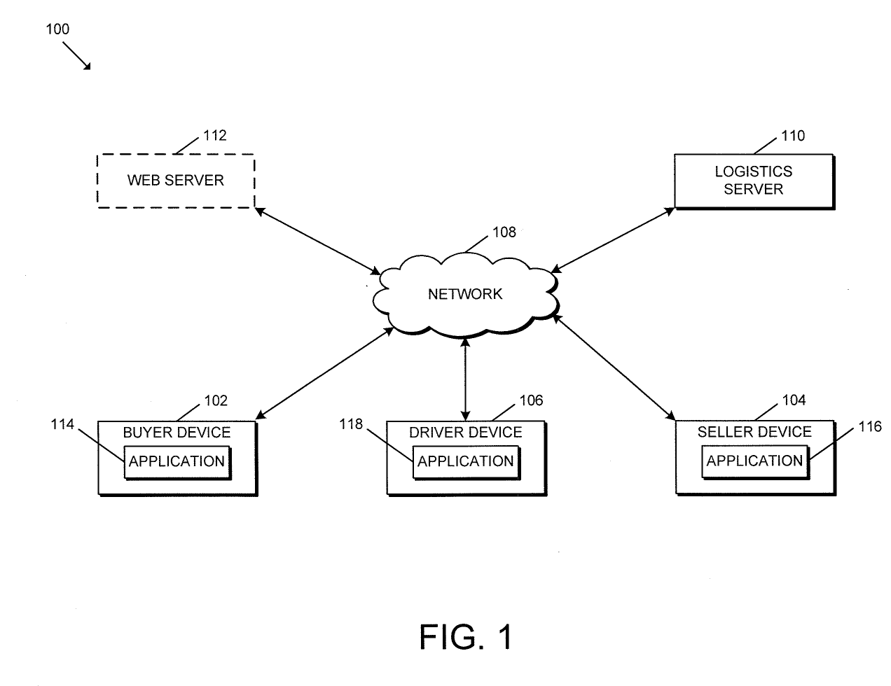

Referring now to FIG. 1, in the illustrative embodiment, a system 100 for facilitating the safe and anonymous transport of goods between a buyer and seller includes a buyer device 102, a seller device 104, a driver device 106, a network 108, and a logistics server 110. Additionally, in some embodiments, the system 100 may include a web server 112. As described in detail below, the system 100 makes transactions and exchanges through online marketplaces/classifieds safer (both physically and financially) by electronically facilitating the financial transaction and coordinating the transport of the relevant item(s)/goods via a vetted independent driver. In use, the system 100 anonymizes the transaction such that the buyer and seller identities and/or locations are never revealed to the other party. In particular, the buyer and seller may communicate with one another using the applications 114 and 116 of the devices 102 and 104, respectively, each of which interact with the logistics server 110. Accordingly, the logistics server 110 is configured to manage the communications between the devices 102, 104. Additionally, the logistics server 110 may perform various analyses (e.g., item identification, driver selection, trends, etc.) and manage the communications with the driver via the application 118 of the driver device 106. In some embodiments, the logistics server 110 may be embodied as, or be configured to communicate with, a web server (e.g., the web server 112).

In an illustrative example, the buyer communicates using and/or interacts with the buyer device 102 (e.g., via a graphical user interface (GUI) of the application 114), the seller communicates using and/or interacts with the seller device 104 (e.g., via a GUI of the application 116), and the driver communicates using and/or interacts with the driver device 106 (e.g., via a GUI of the application 118). It should be appreciated that each of the applications 114, 116, 118 may be embodied as any type of application suitable for performing the functions described herein. In some embodiments, one or more of the applications 114, 116, 118 may be embodied as a mobile application (e.g., a smartphone application), a cloud-based application, a web application, a thin-client application, etc. For example, in some embodiments, one or more of the applications 114, 116, 118 may serve as a client-side user interface (e.g., via a web browser) for a web-based application or service (e.g., of the web server 112).

Additionally, although only one application 114, 116, 118 is shown as being executed by the corresponding devices 102, 104, 106, it should be appreciated that each of the devices 102, 104, 106 may be configured to execute other applications in order to perform the functions described herein. For example, in some embodiments, the buyer/seller may access an online marketplace using another application and engage the application 114, 116 to facilitate the secure transport of an item. Alternatively, in other embodiments, the applications 114, 116 may be integrated with or otherwise incorporated within the online marketplace. Each of the applications 114, 116, 118 may have a GUI for user interaction as described in detail below. The GUIs of the applications 114, 116, 118 may be the same or different depending on the particular embodiment. For example, in some embodiments, the application 114 of the buyer device 102 and the application 116 of the seller device 104 may have the same (or similar) graphical elements, text, and/or options related to the exchange, while the application 118 of the driver device 106 may have the same or different graphical elements, text, and/or options related to the selection of transport jobs and the transport of the corresponding item(s).

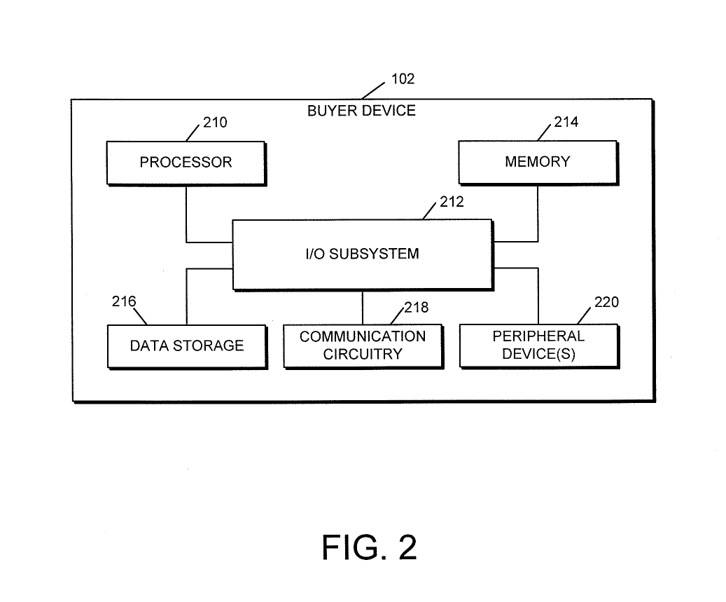

The buyer device 102 may be embodied as any type of computing device capable of performing the functions described herein. For example, the buyer device 102 may be embodied as a smartphone, cellular phone, wearable computing device, personal digital assistant, mobile Internet device, laptop computer, tablet computer, notebook, netbook, Ultrabook™, desktop computer, Internet of Things (IoT) device, server, router, switch, and/or any other computing/communication device capable of performing the functions described herein. As shown in FIG. 2, the illustrative buyer device 102 includes a processor 210, an input/output (“I/O”) subsystem 212, a memory 214, data storage 216, a communication circuitry 218, and one or more peripheral devices 220. Of course, the buyer device 102 may include other or additional components, such as those commonly found in a typical computing device (e.g., various input/output devices and/or other components), in other embodiments. Additionally, in some embodiments, one or more of the illustrative components may be incorporated in, or thereof, may be incorporated in the processor 210 in some embodiments. Although a single buyer device 102 is illustratively shown, it should be appreciated that one or more of the components of the buyer device 102 described herein may be distributed across multiple computing devices. In other words, the techniques described herein may be employed by a computing system that includes one or more computing devices.

The processor 210 may be embodied as any type of processor capable of performing the functions described herein. For example, the processor 210 may be embodied as one or more single or multi-core processors, digital signal processors, microcontrollers, or other processors or processing/controlling circuits. Similarly, the memory 214 may be embodied as any type of volatile or non-volatile memory or data storage capable of performing the functions described herein, such as a cache memory (e.g., an L1 cache, an L2 cache, a last level cache, etc.), a main memory, etc. In operation, the memory 214 may store various data and software used during operation of the buyer device 102 such as operating systems, applications, programs, libraries, and drivers. The memory 214 is communicatively coupled to the processor 210 via the I/O subsystem 212, which may be embodied as circuitry and/or components to facilitate input/output operations with the processor 210, the memory 214, and other components of the buyer device 102. For example, the I/O subsystem 212 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 212 may form a portion of a system-on-a-chip (SoC) and be incorporated, along with the processor 210, the memory 214, and other components of the buyer device 102, on a single integrated circuit chip. For example, in some embodiments, one or more of the components of the buyer device 102 may form one or more application-specific integrated circuits (ASICs).

The data storage 216 (e.g., a secondary memory/data storage device) may be embodied as any type of device or devices configured for short-term or long-term storage of data such as, for example, memory devices and circuits, memory cards, hard disk drives, solid-state drives, or other data storage devices. The data storage 216 and/or the memory 214 may store various data during operation of the buyer device 102 useful for performing the functions described herein.

The communication circuitry 218 may be embodied as any communication circuit, device, or collection thereof, capable of enabling communications between the buyer device 102 and other remote devices (e.g., the logistics server 110) over a network (e.g., the network 108). The communication circuitry 218 may be configured to use any one or more communication technologies (e.g., wireless or wired communications) and associated protocols (e.g., Ethernet, Bluetooth®, WiMAX, etc.) to effect such communication.

The peripheral devices 220 may include any number of additional peripheral or interface devices, such as speakers, microphones, additional storage devices, and so forth. The particular devices included in the peripheral devices 220 may depend on, for example, the type and/or intended use of the buyer device 102. For example, in some embodiments, the peripheral devices 220 may include a keyboard, mouse, display, touchscreen, and/or one or more other suitable peripheral devices 120. Depending on the particular embodiment, the peripheral devices 220 may be separate from or included in a primary housing of the buyer device 102.

The network 108 may be embodied as any type of communication network capable of facilitating communication between one computing device (e.g., the buyer device 102, the seller device 104, the driver device 106, the logistics server 110, the web server 112, etc.) and another computing device (e.g., the buyer device 102, the seller device 104, the driver device 106, the logistics server 110, the web server 112, etc.) communicatively connected via the network 108. As such, the network 108 may include one or more networks, routers, switches, access points, hubs, computers, and/or other intervening network devices. For example, the network 108 may be embodied as or otherwise include one or more cellular networks, telephone networks, local or wide area networks, publicly available global networks (e.g., the Internet), ad hoc networks, short-range communication links, or a combination thereof.

Each of the seller device 104, the driver device 106, the logistics server 110, and the web server 112 may be embodied as any type of computing device capable of performing the functions described herein. In particular, in some embodiments, the seller device 104, the driver device 106, the logistics server 110, and/or the web server 112 may be similar to the buyer device 102 described above. As such, the seller device 104, the driver device 106, the logistics server 110, and/or the web server 112 may include components similar to the components of the buyer device 102 described above and, therefore, the descriptions of those components have not been repeated herein for clarity of the description. Further, it should be appreciated that the seller device 104, the driver device 106, the logistics server 110, and/or the web server 112 may include other components, sub-components, and/or devices commonly found in a computing device, which are not discussed herein for clarity of the description. Additionally, in some embodiments, one or more of the components of the buyer device 102 may be omitted from the seller device 104, the driver device 106, the logistics server 110, and/or the web server 112 (e.g., the peripheral devices 220). In an illustrative embodiment, the buyer device 102, the seller device 104, and the driver device 106 may be embodied as a mobile computing device while the logistics server 110 and the web server 112 may each be embodied as one or more servers.

Although only one buyer device 102, one seller device 104, one driver device 106, one network 108, one logistics server 110, and one web server 112 are shown in the illustrative embodiment of FIG. 1, the system 100 may include multiple buyer devices 102, seller devices 104, driver devices 106, networks 108, logistics servers 110, and/or web servers 112 in other embodiments. For example, in some embodiments, the buyer device 102 may communicate with one web server 112 to access an online marketplace and another web server 112 to open an account for and/or to interact with the logistics server 110 in order to obtain the transport of an item identified in the online marketplace. Further, in some embodiments, the system 100 may include one logistics server 110 to manage communications with client-side interfaces of a shipping application (e.g., a smartphone application) and another logistics server 110 to store a web-based version of the shipping application accessed via a web browser.

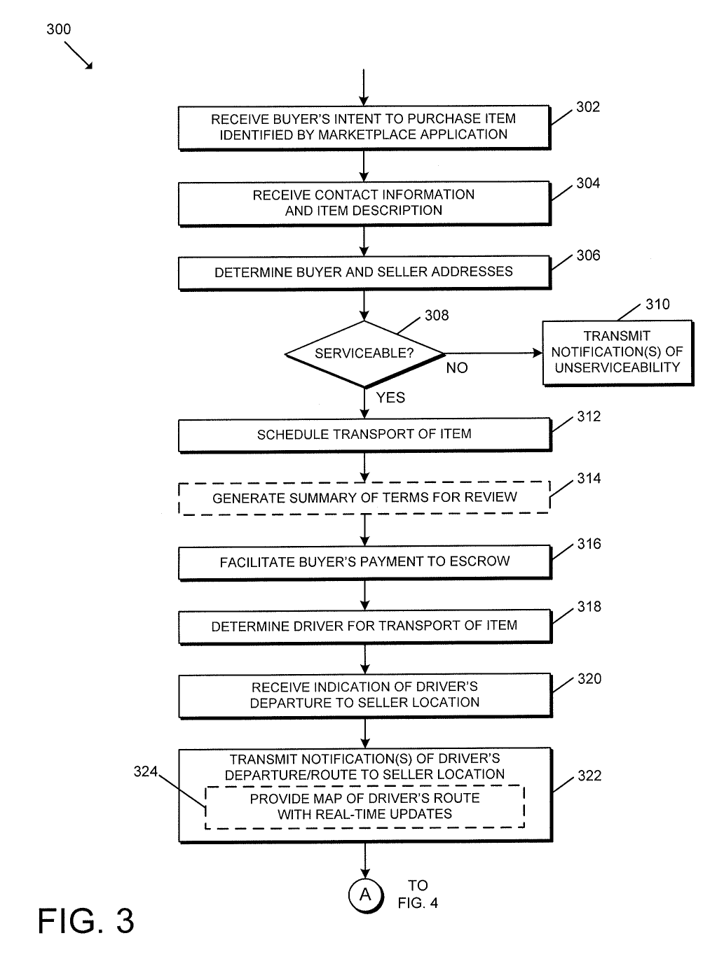

Referring now to FIGS. 3-5, in use, the system 100 may execute a method 300 for facilitating the safe and anonymous transport of goods between a buyer and seller. It should be appreciated that the particular blocks of the method 300 are illustrated by way of example, and such blocks may be combined or divided, performed serially or in parallel, added or removed, and/or reordered in whole or in part depending on the particular embodiment, unless stated to the contrary. The illustrative method 300 begins with block 302 of FIG. 3 in which the logistics server 110 receives the buyer's intent to purchase an item identified by a marketplace application and schedule the item for transport (i.e., pick-up and delivery) via the logistics server 110. For example, the buyer may use the buyer device 102 to access an online marketplace/classifieds application (e.g., via a web browser or a mobile application) and determine that he or she would like to purchase a particular item listed on the online marketplace.

As noted previously, in some embodiments, the online marketplace application may be integrated with the shipping application(s) of the logistics server 110 such that the buyer or seller can identify the desired item depicted within the online marketplace application, negotiate the price, and engage the shipping application to execute the safe and anonymous transport of the identified item. In other embodiments, the online marketplace application may be separate from the shipping application. In such embodiments, either the buyer or the seller may engage the shipping application separately in order to notify the logistics server 110 of the intent to purchase the item and begin electronically facilitating the pick-up of the item from the seller and transport/delivery of the item to the buyer.

It should be appreciated that the buyer and/or seller may create an account with the shipping application/platform at the time of or prior to engaging the logistics server 110 to initiate the transport of the identified item. During account creation, the user may be prompted for his or her name, phone number, pick-up/delivery address(es), email address, username, password, preferences, and/or other suitable information, which may be stored securely by the logistics server 110. The user may receive an email or text message indicating that an account has been created (e.g., with a threshold period to confirm account creation). The logistics server 110 is additionally configured to determine whether the user is located within a currently serviceable geographic area of the shipping application/platform. As such, the email or text message indicating account creation may include information usable by the user to identify whether they are in a serviceable area. In other words, the user may be notified whether he or she is located within a geographic area in which support (e.g., drivers) for the shipping application/platform is operational. Further, if the user is not presently in a supported geographical area, the logistics server 110 may be configured to identify when the geographical area of the user is operational and transmit a notification message to the user at that time to the email address and/or phone number.

In block 304, the logistics server 110 receives contact information of the buyer or seller, whichever is not initiating the transport request, and the description of the item to be purchased and transported. In block 306, the logistics server 110 determines the buyer and seller addresses based on the contact information. To do so, the logistics server 110 is configured to use the contact information to contact the non-initiating party in an effort to receive information usable to identify the non-initiating party and the pick-up or delivery location, such as name, phone number, physical pick-up/deliver address, email address, etc. Specifically, the logistics server 110 may transmit and email or text message to the non-initiating party requesting that party's address/location for transport purposes. Additionally, in some embodiments, the logistics server 110 may prompt the non-initiating party to register an account with the shipping application/platform. In another example, under such conditions in which both the buyer and the seller have accounts with the shipping application/platform, the party initiating the secure transport using the shipping application may provide the other party's shipping application account number or username; otherwise, the initiating party may provide the email address, telephone number, and/or other suitable contact information for the other party that was used as a communication mode (e.g., email, text, etc.) to agree on the sale. As such, communication between with buyer and seller may be facilitated by the logistics server 110 without one party knowing any personal information (e.g., physical home address) of the other party.

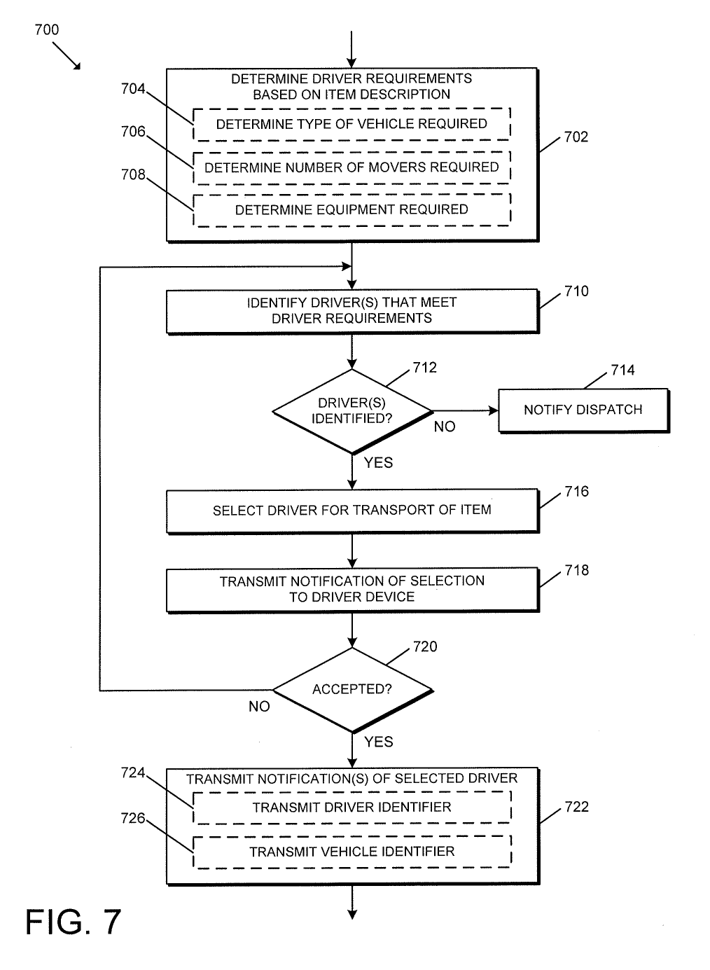

It should be appreciated that the parameters required for the item description may vary depending on the particular embodiments. For example, the item description may identify the type of the item, dimensions of the item (e.g., height/width/depth), weight of the item, other physical characteristics of the item (e.g., materials, durability, etc.), care instructions (e.g., fragile, one side up, etc.), transaction amount, and/or other relevant parameters. In some embodiments, one or more of the item description parameters are selected from pre-defined options on the GUI of the shipping application. For example, the type of the description may be selected from a drop down menu, tree, or other suitable graphical element(s) including a set of pre-defined item types. In some embodiments, the parameters may also identify the number of movers required, the type of equipment required, the recommended vehicle for transport (e.g., car, sport-utility vehicle, truck, etc.), and/or other transport requirements, whereas in other embodiments, one or more of those determinations may be made by the logistics server 110 (see, e.g., block 702 of FIG. 7). It should be appreciated that, in some embodiments, the logistics server 110 may prompt the initiating party for the item description only after the addresses have been determined to be serviceable as described below.

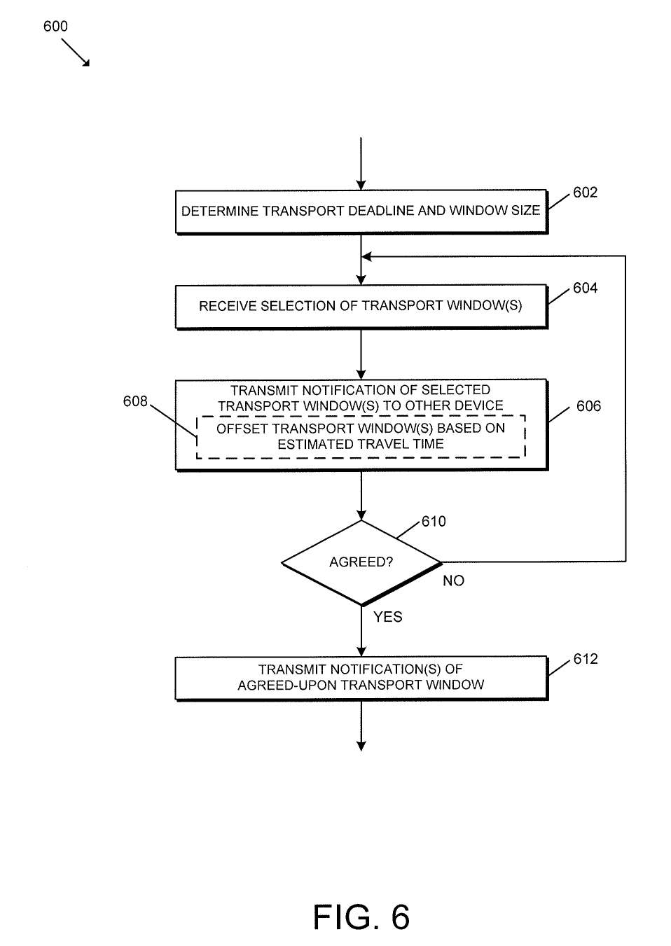

In block 308, the logistics server 110 determines whether the buyer and seller addresses are serviceable. For example, the logistics server 110 may confirm that the buyer and seller addresses are both locations within which the shipping application/platform is operating (i.e., a group of available drivers has been established). Additionally, in some embodiments, the logistics server 110 may determine the distance between the seller address and the buyer address and confirm that the distance between the addresses does not exceed a maximum travel distance, such as may be defined by the shipping application/platform. In other words, in some embodiments, the transport of the item may not be permitted if the buyer and seller are too far away from one another (e.g., if the travel distance exceeds four hours). If the addresses are not serviceable, the method 300 advances to block 310 in which the logistics server 110 may transmit a notification to the buyer device 102 and/or the seller device 104 indicating the unserviceability. However, if the addresses are determined to be serviceable, the method 300 advances to block 312 in which the logistics server 110 schedules the transport of the item(s). To do so, the system 100 or, more specifically, the logistics server 110 may execute a method 600 of FIG. 6.

Referring now to FIG. 6, in use, the logistics server 110 may execute the method 600 for scheduling the transport of the item(s). It should be appreciated that the particular blocks of the method 600 are illustrated by way of example, and such blocks may be combined or divided, added or removed, and/or reordered in whole or in part depending on the particular embodiment, unless stated to the contrary. The illustrative method 600 begins with block 602 in which the logistics server 110 determines a transport deadline and a window size for pick-up and drop-off. Depending on the particular embodiment, the transport deadline and/or window size may be predefined or determined dynamically (e.g., based on the distance between the buyer and seller). In some embodiments, the transport deadline by which the delivery of the item to the buyer address must occur within a particular window (e.g., 1 hours, 2 hours, etc.) from the time of purchase (i.e., pick-up by the driver at the seller's location). In another embodiment, the transport deadline may instead restrict delivery to the end of business on the current day of the transaction (e.g., until 6 pm, 7 pm, 8 pm, etc., on the current day) and/or during business hours of the following day (e.g., 8 am to 8 pm). In some embodiments, the window size(s) within which the pick-up from the seller's address and/or drop-off to the buyer's address may be 1 hour, 2 hours, 3 hours, or 4 hours. In some embodiments, the window size for pick-up may differ from the window size for drop-off. The logistics server 110 may or may not permit a time gap between the pick-up transport window and the drop-off transport window, depending on the particular embodiment.

In the illustrative embodiment, the possible transport windows are presented via the corresponding application 114, 116 for selection by the buyer or seller. In block 604, the logistics server 110 receives the user's selection of one or more possible transport windows and, in block 606, the logistics server 110 transmits a notification of the selected transport window(s) to the other device 102, 104. In doing so, in block 608, the logistics server 110 may offset the transport window(s) by an appropriate time based on an estimated travel time from the seller address to the buyer address. For example, if the estimated travel time is one hour and the seller selects 2-4 pm as the transport window, the logistics server 110 may notify the buyer that the corresponding selected transport window for delivery to the buyer address is 3-5 pm. Similarly, if the estimated travel time is one hour and the buyer selects 2-4 pm as the transport window, the logistics server 110 may notify the seller that the corresponding selected transport window for pick-up from the seller address is 1-3 pm.

If the other party agrees to the selected transport window(s) in block 610, the method 600 advances to block 612 in which the logistics server 110 transmits a notification to the buyer device 102 and/or the seller device 104 of the agreed-upon transport window(s). However, if the other party does not agree, the method 600 returns to block 604 in which the other party (or the initial party) selects one or more alternative transport windows as a counterproposal. In other words, the buyer and seller negotiate until they have come to a resolution regarding the transport window(s). Although the blocks 602-612 are described in a relatively serial manner, it should be appreciated that various blocks of the method 600 may be performed in parallel in some embodiments.

Referring back to FIG. 3, in block 314, the logistics server 110 may generate a summary of transaction terms for review. For example, the transaction amount, item description, selected transport window(s), shipping costs, and/or other relevant information may be displayed for the buyer and/or seller. In block 316, the logistics server 110 facilitates the buyer's payment of the transaction amount and the shipping costs to an escrow account. In some embodiments, it should be appreciated that the seller may pay a portion or all of the shipping costs in which case the logistics server 110 may also prompt the remaining portion of the payment due from the seller. Accordingly, it should be appreciated that, in such embodiments, the summary of transaction terms generated by the logistics server 110 may additionally include the costs to be paid by each party. In block 318, the logistics server 110 determines a driver for transport of the item from the seller address to the buyer address. To do so, the system 100 or, more specifically, the logistics server 110 may execute a method 700 of FIG. 7.

Referring now to FIG. 7, in use, the logistics server 110 may execute the method 700 for determining a driver for the transport of the item(s). It should be appreciated that the particular blocks of the method 700 are illustrated by way of example, and such blocks may be combined or divided, performed serially or in parallel, added or removed, and/or reordered in whole or in part depending on the particular embodiment, unless stated to the contrary. The illustrative method 700 begins with block 702 in which the logistics server 110 determines any driver requirements based on the item description and/or other relevant considerations. In doing so, the logistics server 110 may determine the type of vehicle required to transport the item in block 704 (e.g., based on the item size/shape), the number of movers required to transport the item in block 706 (e.g., based on item size/weight), and/or the equipment required to transport the item in block 708 (e.g., dolly, straps, pads, etc.). It should be appreciated that one or more of the driver requirements may be dictated by regulatory or safety concerns. For example, in some states, additional movers may be required based on the weight of the item. Additionally, the logistics server 110 may further require that the driver be within a certain proximity or travel time (e.g., 30 minutes) from the seller address and/or prioritize nearby drivers.

In block 710, the logistics server 110 identifies the drivers that meet the driver requirements. In particular, in some embodiments, the logistics server 110 may maintain an active drivers pool that includes drivers that are currently “active,” which may include, for example, drivers that are logged into the shipping application 118 on their driver device 106. If no drivers have been identified that satisfy the driver requirements in block 712, the method 700 advances to block 714 in which dispatch is notified. In other words, if the logistics server 110 is unable to identify an appropriate driver, a driver may be manually selected by support personnel. In other embodiments, it should be appreciated that the system 100 may otherwise handle the failure to identify an appropriate driver. If, however, one or more drivers have been identified, the method 700 advances to block 716 in which the logistics server 110 selects one of those drivers for transport of the item. It should be appreciated that the logistics server 110 may select the particular driver from the set of drivers that meet the driver requirements based on any suitable technique, algorithm, and/or mechanism. For example, in some embodiments, the logistics server 110 may select the nearest driver. In other embodiments, the logistics server 110 may randomly select one of the drivers.

In block 718, the logistics server 110 transmits a notification of the driver's selection to the corresponding driver device 106 of the driver. If the driver accepts the job in block 720, the method 700 advances to block 722 in which the logistics server 110 transmits a notification of the selected driver to the buyer device 102 and/or the seller device 104. In doing so, the logistics server 110 may transmit a driver identifier in block 724 and a vehicle identifier in block 726. For example, in some embodiments, the driver identifier may be an image or description of the driver, and the vehicle identifier may be an image or description of the driver's vehicle. As such, the buyer and seller will know what person and vehicle to expect to pick-up and drop-off the item.

If the logistics server 110 determines that the selected driver has not accepted the job in block 720, the method 700 returns to block 710 in which the logistics server 110 again identifies drivers that meet the driver requirements. In other embodiments, it should be appreciated that the logistics server 110 may select another driver from the previously determined set of drivers that meet the driver requirements. However, in some embodiments, the logistics server 110 may regenerate the list of drivers that meet the driver requirements as one or more of the previously identified drivers may now be inactive, outside of the threshold proximity of the seller address, and/or otherwise unable to handle the transport of the item. Further, in some embodiments, after a threshold number of drivers have denied the transport job, the logistics server 110 may notify dispatch to intervene in the selection of an appropriate driver.

Referring back to FIG. 3, in block 320, after the driver has accepted the transport job via the application 118, the logistics server 110 receives an indication of the driver's departure to the seller's location for pick-up. For example, in some embodiments, the driver may select a graphical element in the GUI of the application 118 in order to indicate departure. In other embodiments, the location of the driver device 106 may be monitored (e.g., via global positioning system (GPS) coordinates collected by the driver device 106) and determined to be moving toward the seller's address. In block 322, the logistics server 110 transmits a notification of the driver's departure and/or route to the seller's location to the buyer device 102 and/or the seller device 104. In particular, in block 324, the system 100 may provide a map of the driver's route with real-time updates such that the buyer and/or seller may monitor the location of the driver with respect to the seller's location. It should be appreciated that the map does not show the driver at the buyer or seller's location except to that party—the other party only sees a radius within which the driver is presently located. Additionally or alternatively, the logistics server 110 may provide an estimated time of arrival (ETA) of the driver to the seller's location. Further, in some embodiments, the logistics server 110 may provide an ETA of the driver to the buyer's address following pick-up, the driver identifier, the vehicle identifier, a description of items unauthorized for transport (e.g., items illegal to possess/transport), the invoice (e.g., identifying fees charged for failing to be available for pick-up/delivery), and/or other suitable information.

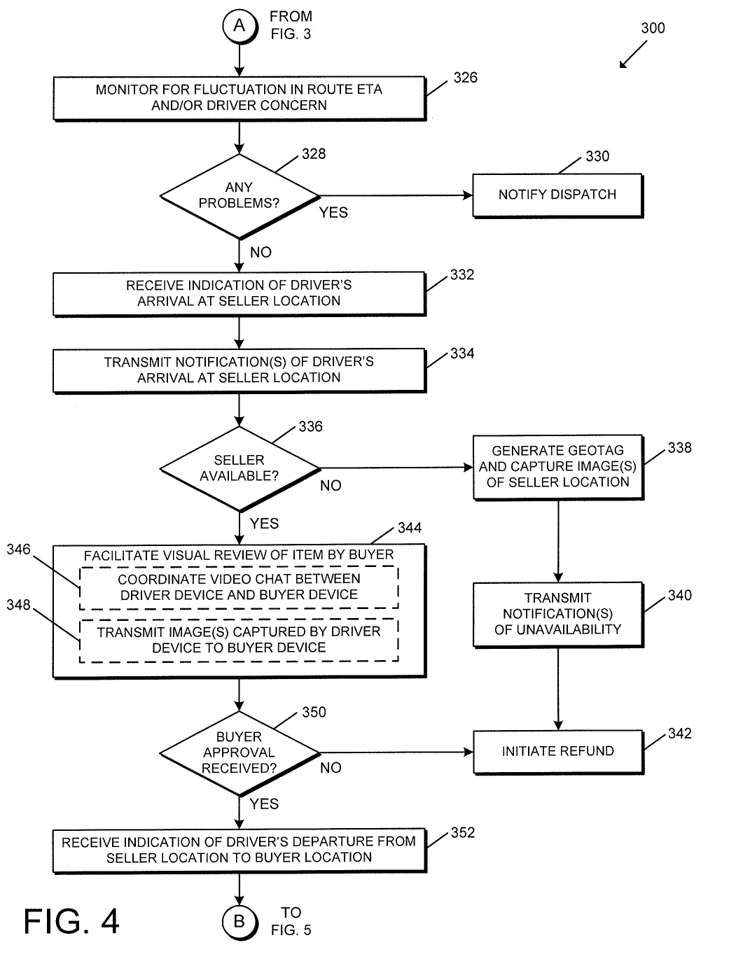

In block 326 of FIG. 4, while the driver is en route to the seller's location, the logistics server 110 monitors for a significant fluctuation in the estimated time of arrival and/or a driver concern. If a problem is identified in block 328, the logistics server 110 notifies dispatch in block 330. For example, in some embodiments, the logistics server 110 may compare the present ETA to the travel time estimate at departure and the elapsed time since departure; if the present ETA plus the elapsed time since departure exceeds the travel time estimate at departure by at least a deviation threshold (e.g., 10 minutes), the logistics server 110 may notify dispatch of the discrepancy. Similarly, if the logistics server 110 determines that the present ETA is outside of the transport window, dispatch may be notified. If a connection is lost with the driver device 106 for at least a threshold period of time, the logistics server 110 may also notify dispatch.

Additionally, in some embodiments, the driver may notify the logistics server 110 via the application 118 of any transport concerns encountered. For example, if the driver has encountered a traffic concern (e.g., an accident, traffic jam, or other hazard that may affect traffic) or a vehicle malfunction, the driver may manually notify the logistics server 110 (e.g., via the application 118 of the driver device 106), which may in turn notify dispatch for a determination regarding a possible delay. In other embodiments, dispatch may be notified directly via the driver application 118. In some embodiments, if the delay will be significant, the logistics server 110 may inform the driver to withdraw from the transport job and identify another driver to handle transport of the item (see, e.g., the method 600 of FIG. 6).

If no problems were encountered that elicited notification, the method 300 advances to block 332 in which the logistics server 110 receives an indication of the driver's arrival at the seller's location. As described above, in some embodiments, the driver may select a graphical element in the GUI of the application 118 in order to indicate arrival at the seller's location. In other embodiments, the logistics server 110 may determine the driver's arrival based on the monitored location of the driver device 106 relative to the seller's location. In block 334, the logistics server 110 transmits a notification of the driver's arrival at the seller's location to the buyer device 102 and/or the seller device 104.

If the seller is determined in block 336 to be unavailable, the method 300 advances to block 338 in which the driver device 106 generates a time-stamped geotag and captures one or more images depicting the driver's presence at the seller's location at the prescribed time. It should be appreciated that the time-stamped geotag and/or captured image(s) may be transmitted to the logistics server 110. Further, in block 340, the logistics server 110 transmits a notification of the unavailability to the buyer device 102 and/or the seller device 104, and in block 342, the logistics server 110 initiates a refund of the buyer's payment from escrow. In some embodiments, it should be appreciated that the seller may be fined for his or her failure to meet at the prescribed time.

If the seller is available, the method 300 advances to block 344 in which the logistics server 110 facilitates a visual review of the item by the buyer. In doing so, in block 346, the logistics server 110 may coordinate a video chat session between the driver device 106 and the buyer device 102. Additionally or alternatively, in block 348, the driver may capture one or more images of the item (e.g., from different perspectives) and/or provide a textual description of the item (e.g., identifying any blemishes) and transmit the images and/or description to the logistics server 110 via the application 118. After review (e.g., via the application 114 of the buyer device 114), if the buyer does not approve the condition of the item, the method 300 may advance to block 342 in which a refund to the buyer may be initiated. However, if the buyer approves the condition of the item, the driver collects the item for transport.

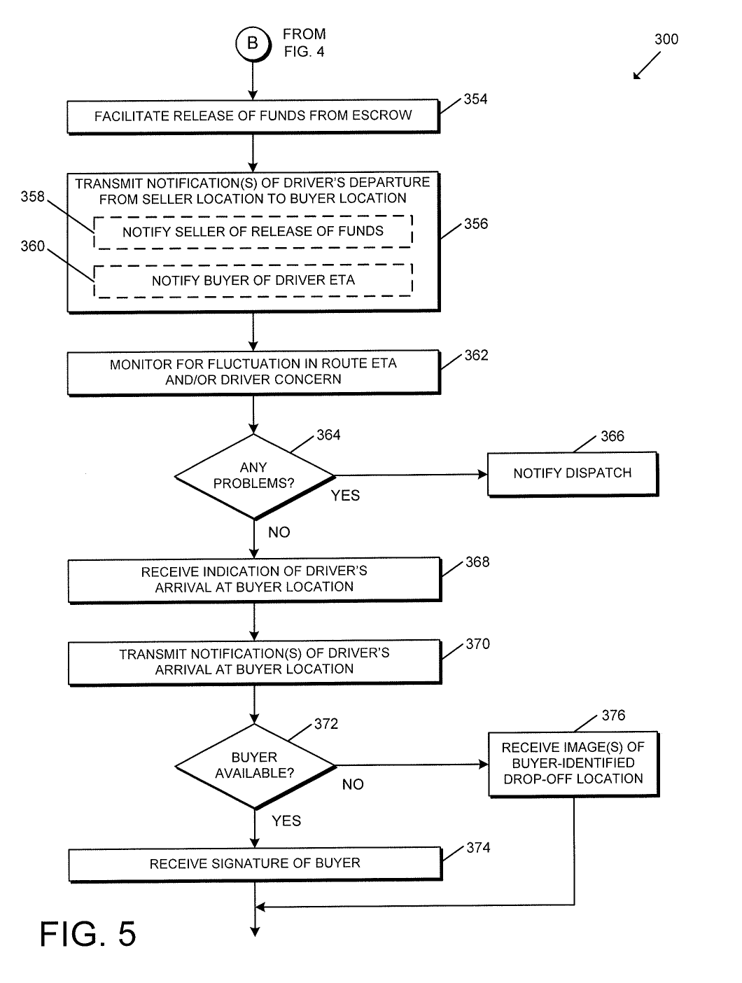

As such, the method 300 advances to block 352 in which the logistics server 110 receives an indication of the driver's departure from the seller's location to the buyer's location. As described above, in some embodiments, the driver may select a graphical element in the GUI of the application 118 in order to indicate departure from the seller's location. In other embodiments, the location of the driver device 106 may be monitored and determined to be moving toward the buyer's location. In block 354 of FIG. 5, the logistics server 110 facilitates the release of funds from the escrow account to the seller. Further, in block 356, the logistics server 110 transmits a notification of the driver's departure from the seller's location to the buyer's location to the buyer device 102 and/or the seller device 104. In doing so, in block 358, the logistics server 110 may notify the seller of the release of funds and, in block 360, the logistics server 110 may notify the buyer of the driver's estimated time of arrival to the buyer's location and/or provide other suitable information. For example, as described above, the system 100 may provide a map of the driver's route with real-time updates such that the buyer and/or seller may monitor the location of the driver with respect to the seller's location.

In block 362, while the driver is en route to the buyer's location, the logistics server 110 monitors for a significant fluctuation in the estimated time of arrival and/or a driver concern in a manner similar to that described above (see, e.g., block 326 of FIG. 4). If a problem is identified in block 364, the logistics server 110 notifies dispatch in block 366 such that the problem can be handled appropriately. If no problems were encountered that elicited notification, the method 300 advances to block 368 in which the logistics server 110 receives an indication of the driver's arrival at the buyer's location. As described above, in some embodiments, the driver may select a graphical element in the GUI of the application 118 in order to indicate arrival at the buyer's location. In other embodiments, the logistics server 110 may determine the driver's arrival based on the monitored location of the driver device 106 relative to the buyer's location. In block 370, the logistics server 110 transmits a notification of the driver's arrival at the buyer's location to the buyer device 102 and/or the seller device 104.

If the buyer is determined to be available in block 372, the method 300 advances to block 374 in which the driver receives a signature from the buyer indicating that the item has been dropped off and accepted. For example, in some embodiments, the driver application 118 may include a mechanism by which the buyer can sign on the driver device 106. As such, the digital version of the buyer's signature may be transmitted to the logistics server 110. Returning to block 372, if the buyer is unavailable, the method 300 advances to block 376 in which the driver captures one or more time-stamped and geo-tagged images of the item being dropped off at the buyer-identified drop-off location. For example, in some embodiments, the buyer may provide instructions to leave the item on the porch, place the item in a garage/mailbox, or otherwise leave the item. In such embodiments, the image(s) serve as visual evidence of the drop-off and the condition of the item at drop-off. The driver may close the transaction by uploading/transmitting the captured image(s) and/or collecting a recorded signature of the buyer (e.g., via the application 118) which is then transmitted to the logistics server 110.

What is claimed is:

1. A method for electronically facilitating the facilitating the safe and anonymous transport of goods between a buyer and seller, the method comprising:
determining a buyer's location and a seller's location;
scheduling transport of the item from the seller's location to the buyer's location;
determining a driver for transport of the item based on a description of the item and a pool of active drivers within a threshold proximity of the seller's location;
monitoring for fluctuations in an estimated time of arrival of driver at each of the seller's location and the buyer's location based on a real-time geographical location of the driver; and
transmitting a notification in response to a determination that the estimated time of arrival has deviated by at least a threshold amount.
